(19) United States
(12) Patent Application Publication
(10) Pub. No.: US 2018/0077646 A1
(43) Pub. Date: Mar. 15, 2018

(54) INTEROPERATING SENSING DEVICES AND MOBILE DEVICES

(71) Applicant: Humberto Jose Moran-Cirkovic, Milton Keynes, Buckinghamshire (GB)

(72) Inventor: Humberto Jose Moran-Cirkovic, Milton Keynes, Buckinghamshire (GB)

(21) Appl. No.: 15/816,580

(22) Filed: Nov. 17, 2017

Related U.S. Application Data
(63) Continuation of application No. PCT/GB2016/051417, filed on May 17, 2016.

(30) Foreign Application Priority Data
May 18, 2015 (GB) 1508534.3

(51) Int. Cl. H04W 52/02; H04W 4/06; H04L 29/08; H04W 4/02; H04L 12/28

(52) U.S. Cl. CPC H04W 52/0225; H04W 4/06; H04L 67/12; H04L 2012/2841; H04L 12/2838; H04W 52/0267; H04L 2012/285; H04W 4/023

(57) ABSTRACT

A method of interoperating sensing devices and mobile devices to enable mobile devices to act upon physical events detected by sensing devices, the method comprising: a sensing device detecting a physical event through sensor; using speaker, said sensing device broadcasting a representation of said physical event using a data audio signal for its reception by a nearby mobile device through its microphone; said nearby mobile device interpreting and using said data audio signal to A. establish distance to said sensing device; B. register said physical event in database; C. offer services to its carrier by means of a user interface; and/or D. generate and, using speaker, broadcast a command audio signal to be captured by microphone of said sensing device to activate actuator and produce further physical event.

### CROSS REFERENCE TO RELATED APPLICATION(S)

This application is a continuation of PCT Patent Application No. PCT/GB2016/051417 filed on May 17, 2016, which claims priority to United Kingdom Patent Application No. 1508534.3 filed on May 18, 2015, the contents of which are all incorporated by reference herein in their entirety.

### BACKGROUND

The upsurge of the so-called “Internet of Things” (IOT hereinafter) has seen the creation of a vast variety of devices (IOT devices hereinafter) capable of interacting with the physical world, intercommunicating, interacting with their carriers and/or enabling mobile applications some of which leverage from the information and communication capabilities of the Internet.

A particular type of IOT device is the so-called “mobile devices”. Also referred to as “wearable devices” or simply “wearables”, mobile devices are those that are designed to be worn or carried by a person, for example mobile phones, smart-phones, tablets, smart-watches, smart-clothes and smart-glasses. A distinctive characteristic of mobile devices is that they can function autonomously and/or wirelessly, i.e. without the need for wire connections for power or communication purposes. Modern mobile devices usually offer application capabilities, i.e. the ability to interact with their carrier by means of user interfaces and software programs or “apps”. Some such applications allow the communication with other users and/or access and update data remotely via the Internet and/or mobile network, for example data in the so-called “cloud” or remote files or databases.

Most IOT devices are capable of interacting with the real or physical world (as opposed to virtual or digital world), particularly by sensing physical events, measuring ambient conditions, and/or moving something, for example by driving an electric motor. We call these “sensing devices”. Devices equipped with buttons or touchscreens are considered sensing devices because the detection of the pushing of a button equates to the detection of a physical event. Sensing devices can be mobile as defined above (mobile devices) or fixed, i.e. designed to be stationary (although they can be moved from time to time). Examples of fixed sensing devices are desktop and server computers, network hubs, home appliances, exercise machines, lights, cash machines, security contraptions, vending machines, street lights, billboards, tills and industrial machinery. Vehicles (cars, planes, ships etc.) can be considered fixed devices because during use they do not move relative to their passengers. Sensing devices are equipped with sensors, which are peripherals capable of measuring local conditions, for example temperature, humidity, pressure and level of light; detecting the movement of an object or person; and/or detecting the action of a user, e.g. the pressing of a button. Sensing devices also include tracking and identification devices, for example fixed radio frequency identification (RFID hereinafter) or bar-code readers, and cameras with automatic object or person-recognition capabilities. Some sensing devices are equipped with actuators that produce a physical event on command, for example open a door or switch a light on; or change ambient conditions, for example temperature or humidity as with an air conditioner. Sensing devices can have only one component, for example a kitchen appliance, or many components, for example a network of RFID readers and transponders.

IOT devices benefit from communicating with each other. Most such devices have advanced communication interfaces allowing the fast, secure and reliable transmission of data. Examples of standard communication interfaces used by IOT devices are Ethernet, USB, Wi-Fi, Bluetooth and ZigBee; and cellular telephony standards such as GSM.

Whilst long- and medium-range communications are already served through the above and other standards, the upsurge of the IOT has revealed the need for local, automatic and short-lived communication links, particularly between sensing and mobile devices casually coming close to each other. Mobile applications could offer more advanced services if they could capture local physical events, for example knowing which product the shopper is picking in a retail store or which appliances a person is using at home. Such events are increasingly captured by ubiquitous sensing devices. These could potentially broadcast the events to nearby mobile devices so their applications can act upon such events. However, mainstream standards for short-range wireless communications, for example Bluetooth and Wi-Fi, require manual setting up or activation commands, are relatively expensive and cannot provide accurate distance or relative position for the intercommunicating devices. This limits their applicability to some valuable IOT applications.

### STATEMENT OF INVENTION

This invention describes a method that allows mobile devices to capture physical events by interoperating with sensing devices. A sensing device uses sensors to detect the movement of nearby people or objects, perceive human or artificial actions, and/or measure local conditions. Physical events, actions and/or measurements include user actions, for example picking or moving an object, opening a door, pressing a button etc.; and non-manual actions, for example when a robot moves a product or when the wind blows a door. Other type of physical events relates to the sensing of local conditions, for example temperature, pressure, level of light or humidity. A physical event can be the combination of a number of physical events that take place within a certain period of time, for example the opening of a door and arrival of a person through that door.

Advantageously, most modern IOT devices are naturally equipped with speakers and microphones, some of which offer infra- and/or ultra-sound capabilities. In this invention, sensing devices use audio signals to broadcast a digitalised code representing the detected physical event and optionally the quantification of the measure, position and/or a time-stamp of the events, the identity of the sensing device, and the identity or identities of the objects and/or people involved in the event. The broadcast audio signals can be audible by humans, or can be inaudible by humans (infra- or ultra-sound). The audio signals can be used to establish the distance or relative position between the mobile device and the sensing device and/or some of its components. Advantageously, the relative slow speed of sound through air in computing terms allows the accurate calculation of the distance between each sender and each receiver, enabling triangulation when two or more senders the relative positions of which are known are involved. In some embodiments this distance or relative position is used to determine whether and/or how the mobile device should act upon the physical event; as it is in the interest of some IOT applications to focus on very local events, for example events generated by or involving its carrier.

### Advantages

The purpose of the invention is to provide applications in mobile devices with local context and so enable valuable IOT services. Apart from improving consumer lifestyle and providing economic advantages, for example through better asset management, the proposed enhanced IOT interoperability offers significant environmental benefits. For example, low-cost sensors can be seamlessly accessed through mobile devices to monitor the refrigeration conditions of perishables and so help to reduce waste, and mobile devices can automatically detect the actions and intentions of their carriers and suggest more efficient ways of doing the same, for example to reduce energy consumption.

### DESCRIPTION

According to a first aspect of the present invention there is provided a method comprising a sensing device detecting a physical event; the sensing device broadcasting a representation of the physical event using a data audio signal for its reception by a nearby mobile device.

This enables the casual, transient interoperation of the sensing device with the mobile device.

The detection of a physical event by the sensing device can be triggered by the occurrence of an event in the physical world. The detection of a physical event by the sensing device can be triggered by the change of one or more ambient conditions. The detection of a physical event by the sensing device can be triggered by the reaching of a pre-determined time measured through its clock. The detection of a physical event by the sensing device can be triggered by the receipt of a command audio signal sent by the mobile device.

The physical event can be the movement of an object. The physical event can be the measurement of an ambient condition. The audio signal can be infra-sound, ultra-sound or audible for humans. The representation of said physical event can be digital or analogue. The data audio signal can be re-broadcast a pre-determined or random number of times on random or pre-established intervals.

The sensing device can be a tracking device capable of detecting the identity and optionally the position of an object or person causing the physical event, and the representation can include the identity of the object or person causing said physical event, and optionally its or their approximate or accurate position.

This allows the mobile device to act upon the identity and/or position of the object or person causing the physical event.

The representation can include the time required to process the detection of the physical event. The representation can include the time-stamp of the detection or registering of the physical event.

There may be one or more further sensing devices broadcasting one or more further representations of the physical event using one or more further data audio signals for their reception by the mobile device.

According to a second aspect of the present invention there is provided a method comprising a mobile device receiving one or more data audio signals corresponding to representations of a physical event detected or registered by one or more sensing devices; and the mobile device acting upon said physical event.

This enables the casual, transient interoperation of a mobile device with nearby sensing devices.

The audio signal can be infra-sound, ultra-sound or audible for humans. The representation of said physical event can be digital or analogue.

The mobile device can use the one or more data audio signals to estimate its distance to at least one of the one or more sensing devices. The distance can be estimated through its strength. The distance can be estimated using the time difference between synchronised clocks in the mobile device and at least one of the one or more sensing devices, such time difference calculated using a time-stamp that is included in at least one representation of the physical event. The distance can also be estimated using the time difference between the broadcast of a command audio signal by the mobile device and the reception of the one or more audio signals from the one or more sensing devices, such estimation optionally considering the processing time of the detection or registering of the physical event, such processing time included in at least one representation of the physical event.

The estimated distance or distances can be used by the mobile device to decide whether and/or how to act upon the physical event.

According to a third aspect of the present invention there is provided a method comprising a mobile device and two or more sensing devices, the mobile device estimating its approximate or accurate position in space relative to at least two of the two or more sensing devices.

The estimated approximate or accurate position in space can be used by the mobile device to decide whether and/or how to act upon the physical event.

According to a fourth aspect of the present invention there is provided a method comprising a mobile device and one or more sensing devices with object and/or person identification and/or tracking capabilities such as RFID networks; wherein at least one of the one or more sensing devices is capable of detecting the identity and optionally the position of an object or person causing a physical event; and wherein the physical event and the identity and/or position of the object and/or person causing the physical event is broadcast using a data audio signal for its reception by the mobile device.

The identity and/or position of the object and/or person causing the physical event can be used by the mobile device to decide whether and/or how to act upon the physical event.

According to a fifth aspect of the present invention there is provided a method comprising a mobile device and one or more sensing devices, the mobile device acting upon a physical event broadcast as a data audio signal by the one or more sensing devices, wherein acting upon the physical event includes registering it in a database, offering information and/or services to the carrier, and/or broadcasting a command audio signal for its reception by at least one of the one or more sensing devices.

According to a sixth aspect of the present invention there is provided a computer program which, when executed by a sensing device, causes the sensing device to perform the method or part of the method.

According to a seventh aspect of the present invention there is provided a computer program which, when executed by a mobile device, causes the mobile device to perform the method or part of the method.

According to an eight aspect of the present invention there is provided a computer readable medium storing the one or both computer programs. The computer readable medium may be a non-transitory computer readable medium.

According to a ninth aspect of the present invention there is provided apparatus for interoperating a sensing device with a mobile device, the apparatus comprising a controller for the sensing device, a sensor for the sensing device, a speaker for the sensing device, storage for the sensing device, and optionally a microphone and an actuator for the sensing device; wherein the apparatus is configured to perform the method or part of the method.

According to a tenth aspect of the present invention there is provided apparatus for interoperating a mobile device with one or more sensing devices, the apparatus comprising a controller for the mobile device, a microphone for the mobile device, storage for the mobile device, and optionally a speaker, a user interface and a wireless interface for the mobile device; wherein the apparatus is configured to perform the method or part of the method.

According to an eleventh aspect of the present invention there is provided apparatus for interoperating two or more devices, the apparatus comprising a mobile device and one or more sensing devices; wherein the apparatus is configured to perform the method or part of the method.

According to a twelfth aspect of the present invention there is provided apparatus for interoperating two or more devices, the apparatus comprising a sensing device and a mobile device; wherein the apparatus is configured so the sensing device detects a physical event and broadcasts a representation of the physical event using a data audio signal for its reception by the mobile device; and the mobile device receives and interprets the data audio signal and acts upon the physical event.

### BRIEF DESCRIPTION OF THE DRAWINGS

Embodiments of the present invention will now be described, by way of example, with reference to the accompanying drawings in which:

FIG. 1 is a schematic block diagram of a system interoperating a sensing device 3 and a mobile device 6;

FIG. 2 is a schematic block diagram of the sensing device 3 shown in FIG. 1;

FIG. 3 is a schematic block diagram of the mobile device 6 shown in FIG. 1;

FIG. 4a is a representation of a physical event 1 to be broadcast as data audio signal 5 (FIG. 1).

FIG. 4b is a representation of a physical event 1 to be broadcast as data audio signal 5 (FIG. 1).

FIG. 4c is a representation of a physical event 1 to be broadcast as data audio signal 5 (FIG. 1).

FIG. 4d is a representation of a physical event 1 to be broadcast as data audio signal 5 (FIG. 1).

FIG. 5 is a representation of a command to be broadcast as command audio signal 15 (FIG. 1).

FIG. 6 is a process flow diagram of the method carried out by the sensor manager 27 (FIG. 1).

FIG. 7 is a process flow diagram of the method carried out by the IOT manager 35 (FIG. 1).

FIG. 8 illustrates interaction of a mobile device 6 and a sensing device 3 to determine distance 9 between them (FIG. 1).

FIG. 9 illustrates interaction of a mobile device 6 and two sensing devices 3₁ and 3₂ to determine the relative position of mobile device 6 (FIG. 1).

FIG. 10 illustrates interaction of a mobile device 6, a sensing device 3, and a tagged object or person 55 to determine the relative position or distance between the mobile device 6 and the tagged object or person 55 (FIG. 1).

### DETAILED DESCRIPTION

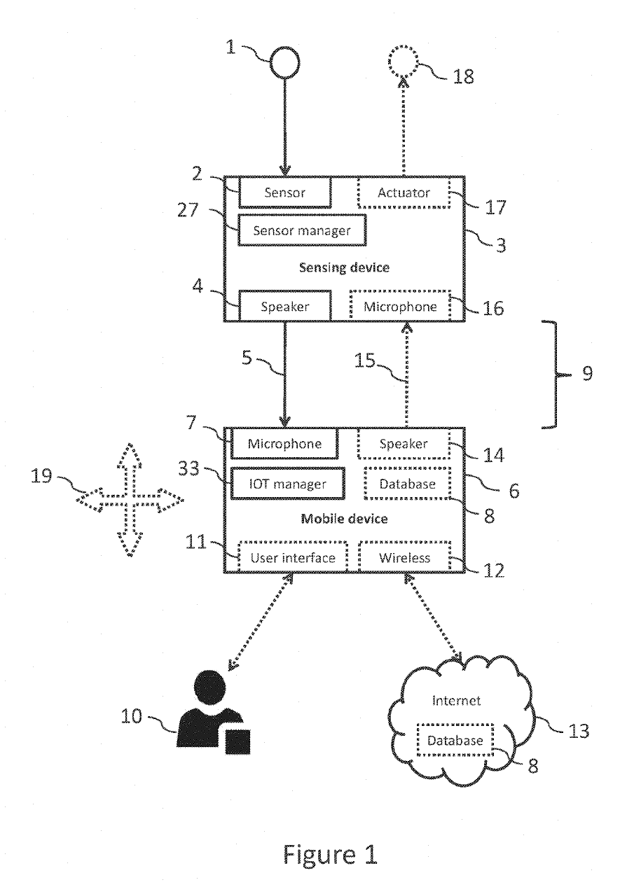

Referring to FIG. 1, a first embodiment of the invention comprises one sensing device 3 and one mobile device 6. In this first embodiment the estimation of the distance 9 between the sensing device 3 and the mobile device 6 is done by measuring the strength of the data audio signal 5.

Sensing device 3 is equipped with a sensor 2 capable of detecting a physical event 1. Physical event 1 can be the movement of an object, or the measurement of an ambient condition, for example temperature or humidity. Sensing device 3 captures a physical event 1 through sensor 2 and generates and broadcasts a representation of the physical event 1 through speaker 4 using data audio signal 5 for detection by nearby mobile device 6. Since it is carried by a person, mobile device 6 can move in any direction in space as illustrated by arrows 19 (also applicable to 3 dimensions) and so dynamically change their distance 9 to the sensing device 3. Mobile device 6 captures audio signal 5 through microphone 7 and interprets and acts upon said data audio signal 5, specifically performing at least one of the following actions:

estimate its distance 9 to said sensing device 3;

register said physical event 1 in local or remote (cloud) database 8;

offer information and/or application services to its carrier 10 by means of a user interface 11, such application services optionally including online services supported by the wireless network interface 12 that allows access to the Internet 13; and/or

generate and, using its speaker 14, broadcast a command audio signal 15 to be captured by microphone 16 of said sensing device 3 in order to activate its actuator 17 and so generate a further physical event 18.

The above actions A to D are dependent on the physical event 1, and actions B to D are further dependent on the estimated distance 9. In other words, the mobile device 6 uses physical event 1 to decide which actions A to D to perform and how to perform them, and estimated distance 9 to further decide which actions B to D to perform and how to perform them.

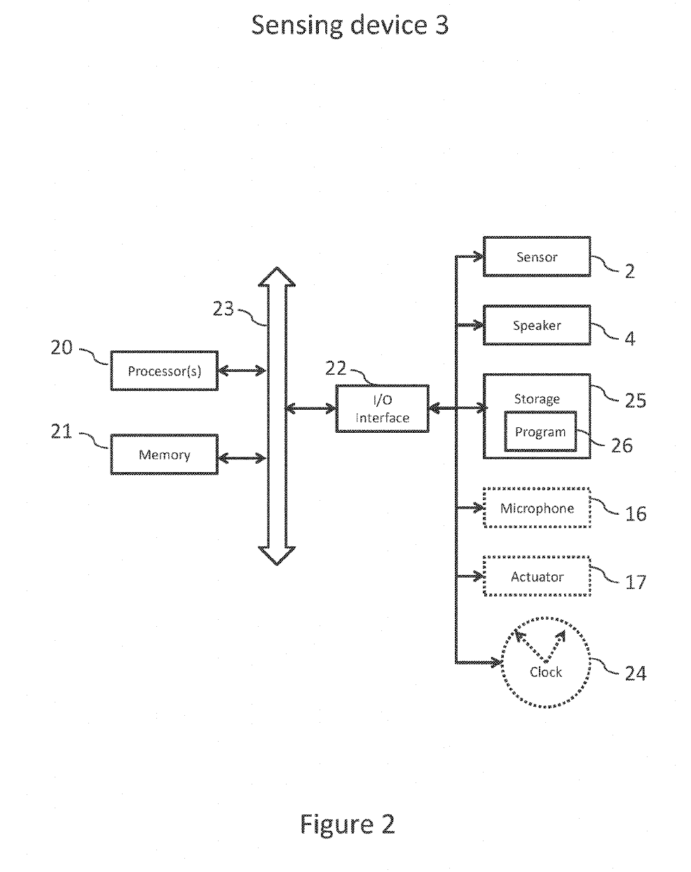

Referring to FIG. 2, sensing device 3 includes one or more processors 20, memory 21 and an input/output (I/O) interface 22 operatively connected by a bus 23. The I/O interface 22 is operatively connected to sensor 2, speaker 4, optional actuator 17, optional microphone 16, optional clock 24, and storage 25 (for example in the form or a hard disk drive or non-volatile memory). Computer program code 26, which when executed causes the sensing device 3 to provide a sensor manager 27 (FIG. 1), is held in storage 25 and loaded into memory 21 for execution by the processor(s) 20.

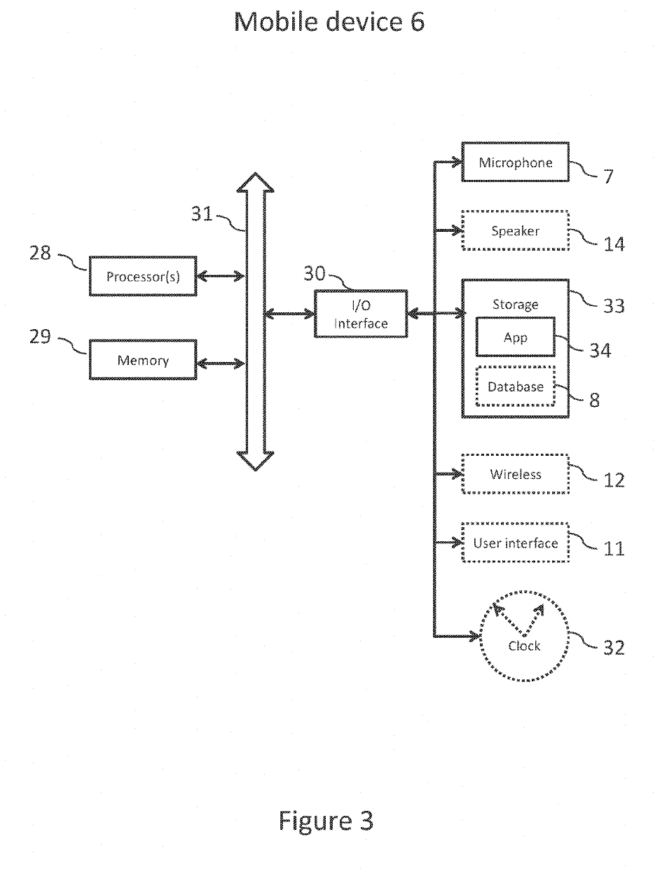

Referring to FIG. 3, mobile device 6 includes one or more processors 28, memory 29 and an input/output (I/O) interface 30 operatively connected by a bus 31. The I/O interface 30 is operatively connected to microphone 7, optional speaker 14, optional wireless network interface 12, optional user interface 11, optional clock 32, and storage 33 (for example in the form of a hard disk drive or non-volatile memory). Computer program code 34, also called an “app”, which when executed causes the mobile device to provide an IOT manager 35 (FIG. 1), is held in storage 33 and loaded into memory 29 for execution by the processor(s) 28. Optional database 8, also held locally in storage 33 and/or remotely in the Internet or “cloud” 13 (FIG. 1), logs the received physical events 1.

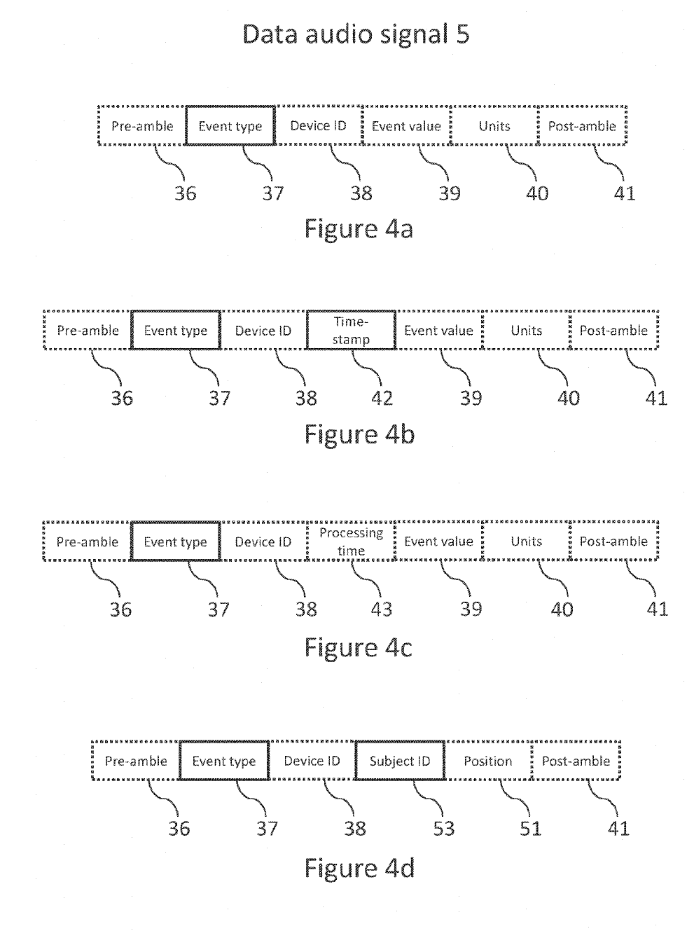

Referring to FIG. 4a, the representation of data audio signal 5 comprises: optionally a pre-amble 36, a type of physical event (e.g. movement of an object or measurement of ambient conditions) 37, optionally the identity 38 of the sensing device that has detected the physical event 1, optionally the event value 39 (for example the value of atmospheric pressure), optionally the units 40 in which such value is expressed (for example PSI), and optionally a post-amble 41. Pre-amble 36 and post-amble 41 are broadcast first and last respectively, while the other elements listed can be transmitted in any order.

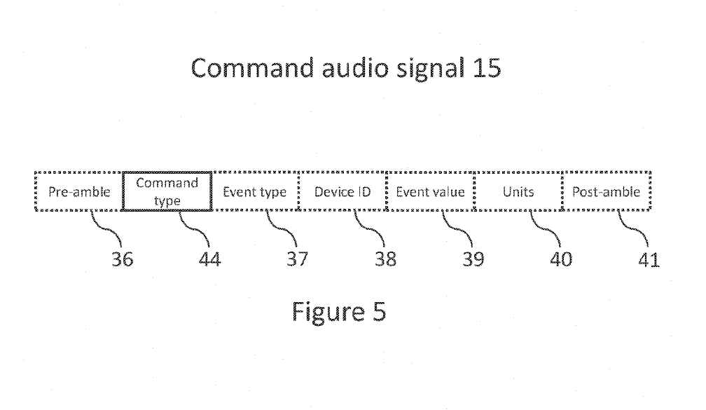

Referring to FIG. 5, the command audio signal 15 comprises optionally a pre-amble 36, a command type 44, optionally a type of physical event (e.g. movement of an object or physical measurement such as temperature, humidity) 37, optionally the identity 38 of the target sensing device (the device to which the command is sent to), optionally the event value 39 (to be measured by the sensor 2 or to be set by the actuator 17, for example the target temperature), optionally the units 40 in which such event value is expressed, and optionally a post-amble 41. Pre-amble 36 and post-amble 41 are broadcast first and last respectively, while the other elements listed can be transmitted in any order. Referring also to FIG. 1, command audio signal 15 can be any of the following: (1) an activation command instructing a sensing device 3 to capture and broadcast a physical event 1, optionally indicating the type of event 37, the units 40 in which such physical event 1 should be expressed, and the device identity 38; (2) an actuation command instructing a sensing device 3 to activate its actuator 17 to produce a physical event 18 of the type 37, optionally indicating the value 39 associated with the event and/or the units 40 in which such physical event 18 is expressed, and optionally the device identity 38; and (3) a setting command instructing a sensing device 3 optionally identified by device identity 38 to behave in a specific way, for example to use specific units 40 as default to express the measurements of a physical event 1 of type 37.

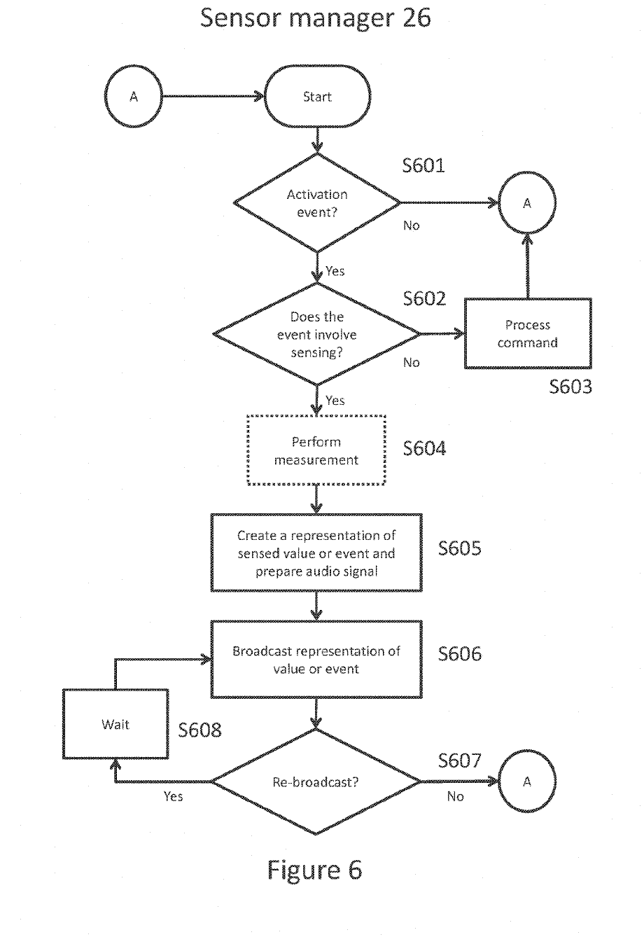

Referring to FIG. 6, in step S601 the sensor manager 27 waits until an activation event takes place. Activation events can be of four different types:

occurrence of a physical event detected through sensor 2, for example the movement of an object;

changes in the value of a physical measurement detected through sensor 2, for example a temperature rise of 0.1° C.;

reaching a pre-scheduled activation time as indicated by clock 24; or

reception through microphone 16 of an activation command, i.e. a command audio signal 15 that matches at least one command from a list of pre-determined activation commands (not shown).

In step 602, if the event involves sensing, specifically if it is an activation event of type (1), (2) or (3) or if the event is an activation command, the sensor manager 27 proceeds to step S604, otherwise in step S603 the sensor manager 27 processes the activation event by undertaking an action that is dependent on the command, for example the activation of actuator 17, and returns to the starting step S601. In the case of activation events (1) and (2) the physical event 1 may already been registered, so step S604 is optional for such types of activation events. In the case of activation events (3) and (4), in step S604 the sensor manager 27 gathers information about the physical event 1 through sensor 2. In step S605 the sensor manager 27 generates a representation of the physical event 1 as data audio signal 5 (FIG. 4a). The representation of the physical event 1 can be digital or analogue (using encoding methods known by the skilled in the art). In step S606 the sensor manager 27 broadcasts the representation of the physical event 1 by means of data audio signal 5 through speaker 4. In step S607 the sensor manager 27 decides whether to re-broadcast according to a retransmission policy, for example to transmit a pre-determined or random number of times. In the case of a re-broadcasting in step S608 the sensor manager 27 waits a pre-determined or randomly-generated amount of time before returning to step S606. Otherwise the sensor manager 27 returns to the starting step S601.

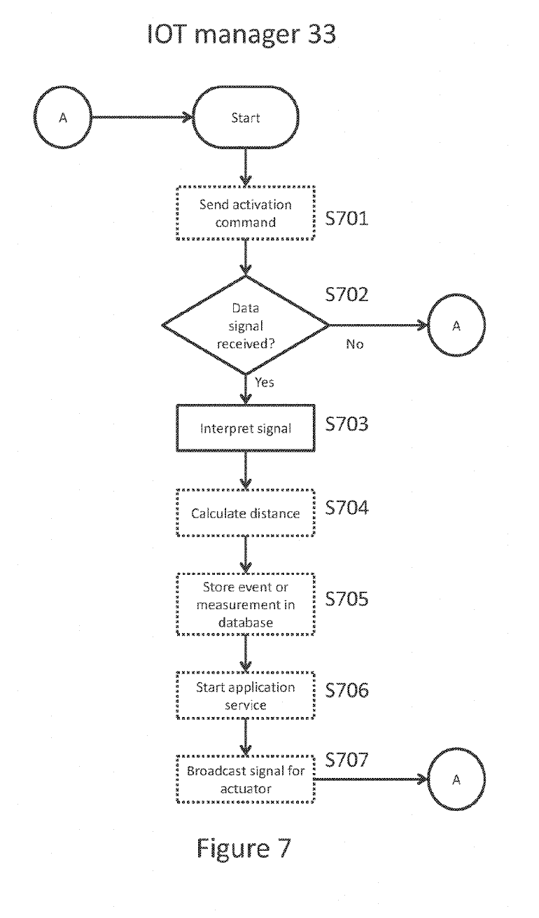

Referring to FIG. 7, in step S701 the IOT manager 35 optionally sends a command audio signal 15 corresponding to an activation command to sensing device 3 in order to trigger the detection of the physical event 1. In step S702 the IOT manager 35 then monitors the microphone 7 of the mobile device 6 for a pre-determined period of time checking for a reply in the form of data audio signal 5, and returns to step S701 if no reply is received. Upon detection of data audio signal 5 in step S703 the IOT manager 35 interprets this signal to decode the data broadcast by the sensing device 3, for example the type of the physical event 1 and, optionally, its value 39, in data audio signal 5 (FIG. 4a). In step S704 the IOT manager 35 optionally estimates the distance 9 between sensing device 3 and mobile device 6 from the strength of data audio signal 5 (stronger means nearer, weaker means farther) according to a pre-determined conversion function or table (not shown). In step S705 the IOT manager 35 optionally stores the physical event 1 in database 8. In step S706 the IOT manager 35 optionally starts an app 34 to offer a service to carrier or user 10 through user interface 11, optionally passing details on physical event 1 and/or distance 9 to the app 34 so the service can be tailored to the local context or events. In step S707 the IOT manager 35 optionally broadcasts a further command audio signal 15 to sensing device 3, for example to activate an actuator 17, and then returns to the starting step S701.

Referring to FIGS. 4b and 7, a second embodiment of the invention is similar in description to the first embodiment of the invention, but differs in that the distance 9 between sensing device 3 and mobile device 6 is estimated by the time difference between the transmission and the arrival of the data audio signal 5. For this, both devices benefit from synchronised clocks: clock 24 and clock 32 (FIGS. 2 and 3 respectively), which are not optional for this embodiment.

Sensing device 3 includes a data field time-stamp 42 in the data audio signal 5 so mobile device 6 can calculate the time it takes for data audio signal 5 to travel from the sensing device 3 to the mobile device 6. Data audio signal 5 is similar in description to that of the first embodiment in FIG. 4a, except for the additional time-stamp 42 data field that records the time at which the data audio signal 5 was broadcast or re-broadcast. In step S704 the IOT manager 35 calculates the distance 9 to the sensing device 3 using the simple formula:

Distance=(Lt−Ts)*Ss

Where Lt is the local time of the mobile device 6, Ts is the time-stamp 42, and Ss is the speed of sound through air. For consistency, the times should be taken at the same moment, for example at the start of the broadcast or reception. Alternatively, the broadcast time can be taken before broadcasting whilst the reception time can be taken after reception, and the duration of the transmission subtracted from the time difference.

A third embodiment of the invention is similar in description to the first embodiment of the invention, but differs in that the distance 9 between sensing device 3 and mobile device 6 is estimated through the time difference between the transmission of an activation command by the mobile device 6 and the reception of the data audio signal 5 by the mobile device 6.

Referring to FIG. 4c, data audio signal 5 is similar in content to that described for the first embodiment in FIG. 4a, but optionally includes a data field processing time 43 that records the time taken by sensing device 3 to undertake the sensing process and broadcast its results to mobile device 6.

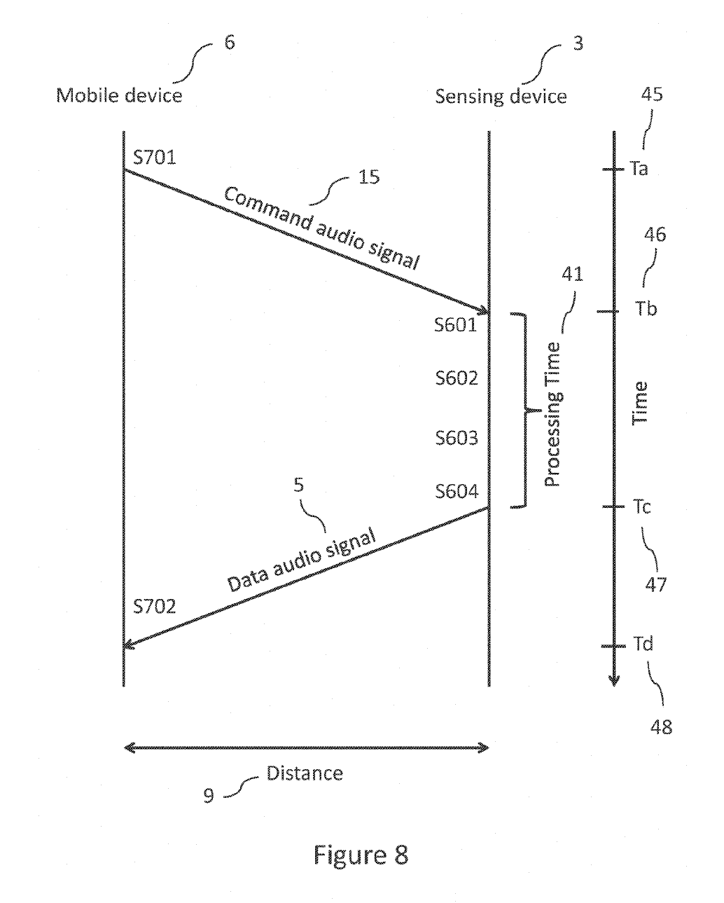

Referring to FIGS. 5, 6 and 7, and in particular to FIG. 8, in step S701 the IOT manager 35 in mobile device 6 prepares and, using speaker 14 (not optional in this embodiment), broadcasts command audio signal 15, such command audio signal 15 matching an activation command of the target sensing device 3 from a pre-specified list (not shown), also registering the time of such broadcast Ta 45 taken from clock 32 (not optional in this embodiment). The sensor manager 27 in sensing device 3 receives command audio signal 15 through microphone 16 (not optional in this embodiment), registers its reception time Tb 46 taking the time from clock 24 (not optional in this embodiment), and triggers a positive activation event in S601, performing steps S602 to S608 as described for the first embodiment. In step S606 the sensor manager 27 registers the reply broadcasting time Tc 47 taking the time from clock 24 and broadcasts a representation of the physical event 1 using data audio signal 5 according to the format described in FIG. 4c, which is similar in description to that of FIG. 4a above, but optionally includes the data field processing time 43 required to detect or undertake the physical event 1, said processing time 43 representing the difference between Tc 47 and Tb 46.

When the IOT manager 35 receives the audio signal 5 in step S702, it registers the reception time Td 48 from clock 32. In step S703 the IOT manager 35 extracts the processing time 43 from the audio signal 5, and in step S704 uses Ta 45, processing time 43 and Td 48 to estimate the distance 9 to the sensing device 3 using the formula:

Distance=(Td−Ta−processing time)*Ss/2

Where Ss is the speed of sound through air and processing time 43 is assumed zero if is not included in data audio signal 5. Since the broadcast of an audio signal itself takes time and for consistency, all times Ta, Tb, Tc and Td should be measured at the same point during broadcasting or reception, for example right after sending or receiving the pre-amble. Alternatively, the duration of each total or partial transmission could be taken into account in the calculations and so generate comparable reference times.

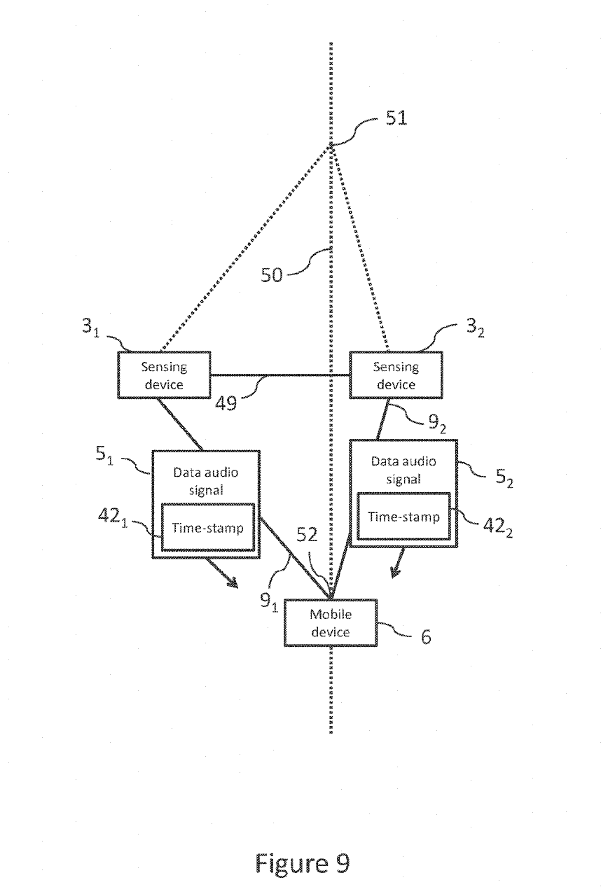

Referring to FIG. 9, a fourth embodiment of the invention is similar in description to the second embodiment, but differs in that there are two sensing devices 3₁ and 3₂ and one mobile device 6. The fixed distance 49 between sensing devices 3₁ and 3₂ is known. In this embodiment the possible position in space of mobile device 6 relative to the two sensing devices 3₁ and 3₂ can be estimated in the following two ways A and B:

A) Differential time-stamp sent by the two sensing devices 3₁ and 3₂: similarly to the described for the second embodiment, the data audio signal 5 sent by each sensing device 3 includes a data field time-stamp 42 (FIG. 4b). Unlike the described for the second embodiment, to estimate its position in space relative to the two sensing devices 3₁ and 3₂ respectively, mobile device 6 does not require a clock 32, but can instead rely on the difference between time-stamps 42₁ and 42₂ sent by the two sensing devices 3₁ and 3₂ in their respective data audio signals 5₁ and 5₂. For this, the two sensing devices 3₁ and 3₂ benefit from synchronised clocks: clock 24₁ and clock 24₂ (FIG. 2), which are not optional for this embodiment. The two sensing devices 3₁ and 3₂ are: (a) are capable of detecting the physical event 1 simultaneously or within a negligible small time difference, and/or (b) are capable of communicating rapidly through a network interface (not shown) in order to share the detection of the physical event 1. From the difference between time-stamps 42₁ and 42₂ and using the simple speed=distance/time formula described for the second embodiment, it is possible to calculate the difference Δ between the distances 9₁ and 9₂ between mobile device 6 and the two sensing devices 3₁ and 3₂ respectively. This difference Δ is then used to calculate the possible position(s) of mobile device 6 as follows:

For simplicity in the algebraic calculation we arrange the coordinates so that sensing device 3₁ is on the origin (0, 0) and that sensing device 3₂ is placed on the X axis (Fd, 0); where Fd is the fixed distance 49 between the two sensing devices 3₁ and 3₂. The possible positions (X₆, Y₆) of mobile device 6 are used to express the difference Δ between the distances 9₁ and 9₂ between mobile device 6 and each of the two sensing devices 3₁ and 3₂ respectively:

Δ=square_root(X₆²+Y₆²)−square_root((X₆−Fd)²+Y₆²)

This implies that, given a distance difference of A, mobile device 6 can only be located on line 50.

Note that when Δ=0 line 50 would be the point right between the two sensing devices 3₁ and 3₂. Without loss of generality it is possible to apply the above logic to 3 dimensions, in which case instead of a line the possible positions for mobile device 6 would constitute a plane individually equidistant to the two sensing devices 3₁ and 3₂.

B) Accurate distances 9₁ and 9₂ between mobile device 6 and the two sensing devices 3₁ and 3₂ respectively: any of the techniques for the estimation of the distance 9 between mobile device 6 and sensing device 3 described for the first three embodiments (strength of data audio signal 5; synchronised clocks X in both sensing devices 3 and mobile device 6; and time taken by the signal to travel between mobile device 6 and sensing device 3, and back) can be used to estimate more accurate positions of mobile device 6 relative to the two sensing devices 3₁ and 3₂. Specifically, knowing the value of distances 9₁ and 9₂ between mobile device 6 and the two sensing devices 3₁ and 3₂ respectively means that the position of mobile device 6 in space can only be either point 51 or point 52, instead of anywhere over a line or plane as with “way A” above. Without loss of generality this logic can be applied to 3 dimensions, in which case the possible positions of mobile device 6 are not limited to two points, but to all points on a circle that is independently equidistant to the two sensing devices 3₁ and 3₂.

Optionally, the mobile device 6 can broadcast a command audio signal 15 to one or more sensing devices 3 in order to activate their actuator 17 and produce a further physical event 18, such sensing devices 3 not necessarily the same sensing devices 3 that initially detected the physical event 1. That is, the sensing device 3 that detects physical event 1 and the sensing device 3 that produces the further physical event 18 may be different devices.

Without loss of generality, the fourth embodiment can be extended to more than two sensing devices 3, noting that the data field device identity 38 may no longer be optional (FIG. 4b) because mobile device 6 needs to be able to find the relative positions of the involved sensing devices 3. As with the well-known Global Positioning System, or GPS, the more sensing devices 3 in the system the more accurate the estimation of the position of mobile device 6 will be, in some cases down to a single point in space. Without loss of generality, the distances 9₁ to 9ₙ between mobile device 6 and each one of the sensing devices 3₁ to 3ₙ can be individually estimated through different methods from those described in the first three embodiments above. Without loss of generality, the set of possible positions (such as line 50, point 51 or point 52) for the mobile device 6 can be expressed as a set of points and/or vectors, and/or as a set of mathematical equations, for example to describe a line, plane, circle or any other geometric figures or combinations of them.

The possible positions in space of mobile device 6 relative to the two sensing devices 3₁ and 3₂ can be used by mobile device 6 to decide whether to act upon the physical event 1, and which actions to perform from the possible actions B to D listed in the first embodiment.

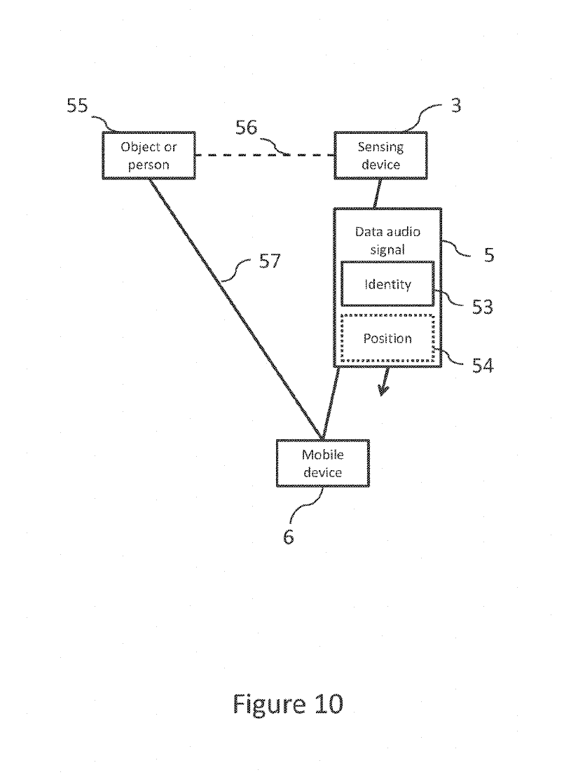

Referring to FIG. 10, a fifth embodiment of the invention is similar in description to the first embodiment, but differs in that sensing device 3 is a tracking or identification device, for example a tracking system capable of determining the identity and approximate or accurate position of nearby objects or persons 55; and particularly the identity and approximate position of objects or persons 55 causing a physical event 1. Examples of tracking devices are RFID systems capable of tracking objects or persons tagged with transponders, and devices with object- and/or person-recognition capabilities, for example a camera with biometric (person recognition) capabilities.

Sensing device 3 is capable of detecting the identity and optionally the approximate or accurate position and/or movement of object or person 55 through tracking interface 56, which could be electromagnetic, acoustic, visual or of another nature (irrelevant for this invention). Referring as well to FIG. 4d, upon detection of a physical event 1 involving object or person 55, for example the movement of an object, sensing device 3 broadcasts data audio signal 5 indicating the type of physical event 1, the identity 53 of the object or person 55, and optionally the approximate or accurate position of the object or person relative to sensing device 3, which is position 54. Position 54 can be expressed as 2D or 3D Cartesian vectors, a combination of angles and distances, or any other way of expressing approximate or accurate position in 2D or 3D space, for example a set of points and/or vectors, and/or as a set of mathematical equations, for example to describe a line, plane, circle or any other geometric figures or combinations of them. The identity 53 of the object or person 55 causing the physical event 1 can be used by the IOT manager 35 in mobile device 6 to decide whether to act upon the physical event 1, and which actions to perform from the possible actions A to D listed in the first embodiment.

As in the fourth embodiment, the fifth embodiment can be implemented with more than one sensing device 3 and so calculate the approximate or accurate position of mobile device 6, which can in turn be used to calculate the distance 57 between object or person 55 and mobile device 6 when position 54 is available, or the position of object or person 55 relative to mobile device 6. Position 54, distance 57 or the relative position between object or person 55 and mobile device 6 can be used by the IOT manager 35 in mobile device 6 to decide whether to act on the received physical event 1, and which actions to perform from the possible actions B to D listed in the first embodiment.

Without loss of generality, the fifth embodiment can use more than one object or person 55. The person- or object-recognition devices can use images, sound, smell or any other physical attributes, or a combination of them. In case of a transponder system, the transponders may be passive or active. The transponders may be used to give an approximate or precise location of object or person 55. The transponders may include sensors 2 and transmit sensed events to the sensing devices 3 that are tracking them, which in turn will broadcast such physical events 1 to nearby mobile devices 6 as described. The transponders may include actuators 17 that are activated remotely (through tracking interface 56) by sensing device 3 upon receipt of a command audio signal 15. The set of possible positions (such as line 50, point 51 or point 52) for the mobile device 6 or approximate or accurate position 54 for the object or person 55 causing the physical event 1 can be expressed as a set of points and/or vectors, and/or as a set of mathematical equations, for example to describe a line, plane, circle or any other geometric figures or combinations of them.

It will be appreciated that many modifications can be made to the embodiments herein-before described. For instance, more than one sensing device 3 can interoperate with one or more mobile devices 6, and more than one mobile device 6 can interoperate with one or more sensing devices 3. Sensing devices 3 can have more than one sensor 2 and more than one actuator 17. Sensing devices 3 can detect and broadcast more than one physical event 1 at the same time. Sensing devices 3 can represent different physical events 1 in different formats.

Features of the different embodiments can be combined in further embodiments. For example, sensing device 3 can broadcast data audio signal 5 that has both tracking information as described in FIG. 4d and time-stamp information as described in FIG. 4b.

1. A method comprising:
detecting, with a sensing device, a physical event involving one or more nearby objects or persons;
wherein the sensing device identifies at least one of said one or more nearby objects or persons; and
wherein the sensing device broadcasts a representation of said physical event using a data audio signal for its reception by said mobile device, wherein said representation includes one or more identities of said one or more nearby objects or persons.

2. A method according to claim 1, wherein said sensing device uses RFID transponders to establish the identity of said one or more objects or persons.

3. A method according to claim 1, wherein said sensing device uses one or more images to establish the identity of said one or more objects or persons.

4. A method according to claim 1, wherein said sensing device uses sound to establish the identity of said one or more objects or persons.

5. A method according to claim 1, wherein said sensing device uses a combination of RFID transponders, images, sounds, smells and/or any other physical attributes to establish the identity of said one or more objects or persons.

6. A method according to claim 1, wherein:
said sensing device is further capable of detecting the approximate or accurate position of at least one of said one or more nearby objects or persons involved in said physical event; and
said representation includes said approximate or accurate position of said at least one of said one or more objects or persons involved in said physical event.

7. A method according to claim 1, the method further comprising:
one or more further sensing devices broadcasting one or more further representations of said physical event using one or more further data audio signals for their reception by said mobile device.

8. A method of interoperating a mobile device with one or more sensing devices, the method comprising:
said mobile device receiving one or more data audio signals corresponding to one or more representations of a physical event detected by said one or more sensing devices, wherein:
i. said physical event involves one or more nearby objects or persons; and
ii. said one or more representations include one or more identities of said one or more nearby objects or persons; and
said mobile device acting upon said physical event.

9. A method according to claim 8, wherein the method further comprises:
said mobile device using said one or more data audio signals to estimate its distance or distances to at least one of said one or more sensing devices and wherein acting upon said physical event is dependent upon said estimated distance or distances.

10. A method according to claim 9, the method further comprising:
said mobile device initially broadcasting a command audio signal for reception by at least one of said one or more sensing devices and wherein said estimated distance or distances to said at least one of said one or more sensing devices are estimated using the time difference between broadcasting said command audio signal and receiving said one or more data audio signals.

11. A method according to claim 8, further comprising:
detecting, with a sensing device, a physical event involving one or more nearby objects or persons;
wherein the sensing device identifies at least one of said one or more nearby objects or persons; and
wherein the sensing device broadcasts a representation of said physical event using a data audio signal for its reception by said mobile device, wherein said representation includes one or more identities of said one or more nearby objects or persons.

12. A method comprising according to claim 8, further comprising:
one or more further sensing devices broadcasting one or more further representations of said physical event using one or more further data audio signals for their reception by said mobile device.

13. A method according to claim 9, further comprising:
detecting, with a sensing device, a physical event involving one or more nearby objects or persons;
wherein the sensing device identifies at least one of said one or more nearby objects or persons; and
wherein the sensing device broadcasts a representation of said physical event using a data audio signal for its reception by said mobile device, wherein said representation includes one or more identities of said one or more nearby objects or persons,
said mobile device using said one or more data audio signals to estimate its distance or distances to at least one of said one or more sensing devices and wherein acting upon said physical event is dependent upon said estimated distance or distances.

14. A method comprising:
performing a method according to claim 11 wherein acting upon said physical event is dependent upon at least one of said identity or identities of said one or more nearby objects or persons involved in said physical event.

15. A method according to claim 8, wherein:
said sensing device is further capable of detecting the approximate or accurate position of at least one of said one or more nearby objects or persons involved in said physical event; and
said representation includes said approximate or accurate position of said at least one of said one or more objects or persons involved in said physical event,
wherein acting upon said physical event is dependent upon said approximate or accurate position of said one or more nearby objects or persons involved in said physical event.

16. A computer program product comprising a non-transitory computer readable medium storing thereon a computer program which, when executed by a computing device causes the computing device to perform a method according to claim 1.

17. A computer program product comprising a non-transitory computer readable medium storing thereon a computer program which, when executed by a computing device causes the computing device to perform a method according to claim 8.

18. Apparatus for interoperating a sensing device with a mobile device, the apparatus comprising:
a controller for said sensing device;
a sensor for said sensing device;
a speaker for said sensing device;
storage for said sensing device; and
optionally a microphone and an actuator for said sensing device;
wherein the apparatus is configured to perform a method according to claim 1.

19. Apparatus for interoperating a mobile device with one or more sensing devices, the apparatus comprising:
a controller for said mobile device;
a microphone for said mobile device;
storage for said mobile device; and
optionally a speaker, user interface and wireless interface for said mobile device;
wherein the apparatus is configured to perform a method according to claim 8.

20. Apparatus for interoperating two or more devices, the apparatus comprising:
one or more sensing devices; and
a mobile device;
wherein the apparatus is configured to perform a method according to claim 11.

21. Apparatus for interoperating two or more devices, the apparatus comprising:
one or more sensing devices; and
a mobile device;
wherein the apparatus is configured to perform a method according to claim 12.

22. Apparatus for interoperating two or more devices, the apparatus comprising:
one or more sensing devices; and
a mobile device;
wherein the apparatus is configured to perform a method according to claim 13.

23. Apparatus for interoperating two or more devices, the apparatus comprising at least:
a sensing device; and
a mobile device;
wherein the apparatus is configured so:
said sensing device:
i. detects a physical event that involves one or more nearby objects or persons,
ii. identifies at least one of said one or more nearby objects or persons, and
iii. broadcasts a representation of said physical event using a data audio signal for its reception by said mobile device; and
said mobile device receives and interprets said data audio signal and acts upon said physical event.
